(19) United States
(12) Patent Application Publication
(10) Pub. No.: US 2005/0127681 A1
(43) Pub. Date: Jun. 16, 2005

(54) Electric power generating machines

(76) Inventor: Dou Shaochun, Yangzhou (CN)

Correspondence Address: LEWIS F. GOULD, JR.;DUANE MORRIS LLP, ONE LIBERTY PLACE, PHILADELPHIA, PA, 19103, US

(21) Appl. No.: 10/737,548

(22) Filed: Dec. 16, 2003

(51) Int. Cl. H02P 9/04; F03B 13/00

(52) U.S. Cl. 290/54

(57) ABSTRACT

A machine has a potential energy raising device comprising a base container containing a liquid. A column has an upper gate at its top and a lower gate. The column extends above the base container and the column's bottom is below a liquid surface of the base container. A float is less dense than the liquid and denser than an ambient gas. A gas extraction path connects the upper gate to a pump to extract gas from the column. A guide in the liquid guides the float into the bottom of the column, so the float can float to the top of the column. A potential energy-kinetic energy conversion device near the potential raising device converts a potential energy of the float into kinetic energy when the float drops.

### FIELD OF THE INVENTION

The present invention relates to electric power generating machines, and more particularly to electric power generating machines utilizing potential energy-kinetic energy conversion.

### BACKGROUND

Problems regarding energy sources are currently attracting worldwide attention. With a continued increase in the amount of energy sources needed by human beings, exploration of petroleum, coal and natural gas also increases and the available energy resources on earth continue to decrease. Finding new ways to search for new energy resources has already become an important task for scientists and engineers in the field of energy resources in the world.

At present, energy sources other than petroleum, coal and natural gas include utilization of solar energy, nuclear energy and water conservation.

Utilization of solar energy on earth can be constantly and easily affected by the change in weather. Its utilization efficiency is relatively low and thus the cost of investment is correspondingly high. Use of a solar energy-collecting device installed on a satellite in outer space can eliminate the effects of cloud layers but transport of the energy source is extremely difficult and the cost of investment is enormous. Therefore, large-scale utilization of solar energy always results in failure.

Conversion of reaction energy to electric energy through controlled nuclear reactions can avoid large-scale exploration of resources and the energy production efficiency is very high. However, safe control of nuclear reactions is extremely complex and the cost of investment is extremely high. The risks of accidental nuclear leakage to the natural environment and to human beings are beyond estimation. Similarly, the materials for the nuclear reactions are also very rare resources on earth.

Utilization of water conservation resources mainly involves hydraulic electric power generation and tidal electric power generation. At present, they are one of the relatively good ways to acquire an energy source. They utilize the potential energy difference created spontaneously by nature and the energy created by the tidal surge for electric power generation. They are a clean and unlimited natural resource. However, hydraulic electric power generation can be affected by the regional and geographic locations and requires construction of a large dyke and dam or interception of a river. Such an engineering undertaking and the cost of investment are enormous. Furthermore, the cost of daily maintenance is also very high. Similarly, the tidal electric power generation can be restricted by regional problems. It cannot be carried out in an inland region and can also be affected by the frequency of spring tide.

The force of wind can also generate electric power. Although the investment cost of construction of such an electric power generator is relatively small, it similarly can be affected by regional and geographic conditions. Even the normal electric power generation capacity of a wind electric power generation facility installed at the wind gap of mountain valleys can be affected by the change in the force of wind.

In short, although we have made great progress in the way we acquire natural non-extractable energy sources, many problems and insufficiencies still remain. Therefore, while we are constantly looking for a better format for utilizing natural resources, we should continue to recognize and search for natural energy source phenomena that have not been recognized so far so that we can expect further utilization of the natural energy source. In fact, many natural phenomena involve natural energy to some extent. Rational and skillful development and utilization of such energies can provide human society with enormous, limitless and nonpolluting energy sources. This is also the goal of the endless efforts made by the energy source scientists and engineers.

### SUMMARY OF THE INVENTION

A machine comprises a potential energy raising device and a a potential energy-kinetic energy conversion mechanism. The potential energy raising device comprises a base container containing a liquid. A columnar container has an upper gate disposed approximately at the top of the columnar container. The columnar container extends above the base container, and a bottom end of the columnar container is below a liquid surface of the base container. A lower gate is located to partition the liquid in the columnar container. A float has a density smaller than a density of the liquid and larger than an ambient gas density. The float is capable of being dropped from approximately the top of the columnar container. A gas extraction path is coupled to the upper gate and coupled to a pump to extract gas from the columnar container. A guide is disposed in the liquid to guide the float into a lower part of the columnar container, so the float can float upwards in the columnar container. The potential energy-kinetic energy conversion mechanism is disposed near the potential raising device, for converting a potential energy of the float into kinetic energy when the float drops.

### BRIEF DESCRIPTION OF THE DRAWINGS

A more complete understanding of the present invention can be obtained by reference to the detailed description of embodiments in conjunction with the accompanying drawings, in which:

FIG. 1 is a schematic diagram showing the structural principle of an example provided by the present invention;

FIG. 2 is a schematic diagram showing the structure of the auxiliary float raising device used in the example;

FIG. 3 is a schematic diagram showing the structure of the float used in the example;

FIG. 4 is a schematic diagram showing the structure of the airtight sealing rubber ring of the lower airtight sealing gate used in the example.

### DETAILED DESCRIPTION

The present invention will be described in greater detail with the use of the concrete examples and attached figures given below.

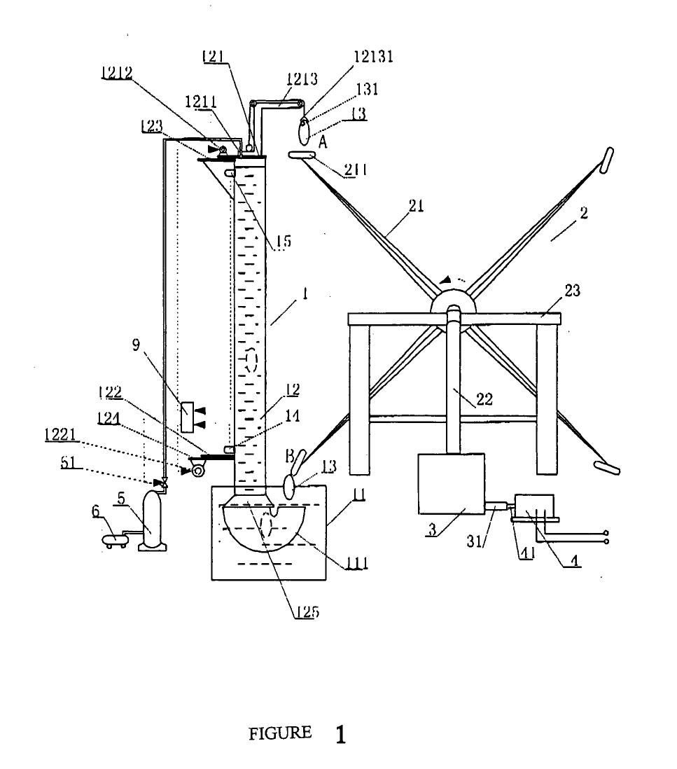

Base on Torricelli's experimental phenomenon, a concrete example was created. The principal structure of this example is shown in FIG. 1.

The facility used in this example includes the potential energy raising devise (1), the potential energy-kinetic energy conversion device (2), the transmission mechanism (3) and the electric power generator (4). The rotation output axle (31) of the transmission mechanism (3) is connected to the rotating axle (41) of the electric power generator (4).

The potential energy raising device (1) includes the water pool (11) filled with water, the columnar container (12) having the upper airtight sealing gate (121) installed on its upper end and the float (13). The specific gravity of the float (13) is 0.9. The wireless signal-transmitting device (131) is installed on the float (13).

The columnar container (12) is erected on the water pool (11) and its bottom end surface is located below the water surface. When the upper airtight sealing gate (121) is closed, the top part of the columnar container (12) is sealed tightly by the sealing mechanism. The gas extraction mouth (1211) is installed on the surface of the upper airtight sealing gate (121). The gas extraction mouth (1211) is connected to the external vacuum pump (6) through the negative pressure tank (5). The electromagnetic valve (51) is installed between the negative pressure tank (5) and the gas extraction mouth (1211).

The columnar container (12) is also equipped with the lower airtight sealing gate (122) for partitioning water in the columnar container (12). The lower airtight sealing gate (122) is installed at the lower half of the columnar container (12). Its distance from the surface of water in the columnar container (12) is much greater than the maximum external size of the float (13).

The water pool (11) is also equipped with the guiding groove (111) for allowing the float (13) to move horizontally when it is dropped into the water pool (11). The guiding groove (111) is a circular arc-shaped tube; its exit port end is located below the sealing port end of the columnar container (12) and its entrance port end is located at the position where the float (13) is to be dropped into the water pool. The conical-shaped guiding inlet port (125), which opens downwardly, is installed around the opening port at the bottom end of the columnar container (12) and the open port of the conical-shaped guiding inlet port (125) is adjacent to the opening port end of the guiding groove (111).

The platform (123) is installed horizontally at the outside of the top end of the columnar container (12). The upper airtight sealing gate (121) is installed on the surface of the platform (123) through a sliding unit. At the same time, the upper airtight sealing gate driving motor (1212) is installed on the surface of the upper airtight sealing gate (121) for opening and closing the upper airtight sealing gate (121).

The hoist (1213) for removing the float (13) from the columnar container (12) is installed on the surface of the upper airtight sealing gate (121). A winding machine and a cable are installed on the hoist (1213) and one end of the cable is equipped with the grab hook (12131) capable of automatic closing/opening.

The lower airtight sealing gate (122) is also equipped with the lower level platform (124) and the lower airtight sealing gate driving motor (1221) is also installed on the lower level platform (124) (the driving motor can also installed directly on the surface of the extended part of the lower airtight sealing gate (122)).

In addition, the upper level wireless signal receiver (15) and the lower level wireless signal receiver (14) are installed at the upper airtight sealing gate (121) and the lower airtight sealing gate (122), respectively.

The potential energy-kinetic energy conversion device (2) is disposed near the potential raising device, for converting a potential energy of the float into kinetic energy when the float drops. This mechanism includes four extension arms (21), the rotating axle (22) and the support frame (23). The bottom end of the extension arm (21) is fixed onto the rotating axle (22). The extension arm is extended outwardly and radiantly along the direction of the diameter of the rotating axle (22) to form a windmill-like rotating unit. The rotating axle (22) is erected on the support frame (23) and is connected to the rotation input end of the transmission mechanism (3). The float holding part (211) is installed on the top end of each of the extension arms (21). When the float (13) is removed from the top of the columnar container (12), one of the four float holding parts (211) will locate itself at the bottom part of the float (13).

After the vacuum pump (6) used in the present example completes evacuation of the inside part of the columnar container (12), water enters the columnar container (12) to form a water column. When the atmospheric pressure outside is equal to one standard atmospheric pressure, the height of the water column is about 10 m. When the float (13) is dropped into the water pool (11) at position B, the float (13) will continue to sink under the action of inertia. The sloped side wall of the guiding groove (111) will allow the float (13) to move sideways to reach the open port at the bottom end of the columnar cylinder (12). Because of the actions of buoyancy and resistance of water, the float (13) will gradually stop sinking and start to float upwards. Under the guidance of the conical guiding port (125), the float (13) will enter the columnar container (12) and start to float upwards. When the float (13) passes through the lower airtight sealing gate (122), the lower level wireless signal receiver (14) will receive a signal emitted from the wireless signal emission device (131) installed on the float (13). The signal is transmitted to the external signal processing device (9). The external signal processing device (9) will actuate the lower airtight sealing gate driving motor (1221) installed on the lower level platform (124) to close the lower airtight sealing gate (122) and cut off water in the columnar container (12). As the float (13) moves upwards and gets closer to the top part, the upper level wireless signal receiver (15) will receive a signal emitted from the wireless signal emitting device (131). This signal is also transmitted to the external signal processing device (9). The external signal processing device (9) will actuate the upper airtight sealing gate driving motor (1212) installed on the surface of the upper airtight sealing gate (121) to open the upper airtight sealing gate (121). At the same time, the hoist (1213) installed above the surface of the upper airtight sealing gate (121) is actuated and releases the cable. The grab hook (12131) will buckle up the float (13) and the hoist will rotate to lift the float (13). When the float (13) is taken out of the columnar container (12), the upper level wireless signal receiver (15) can no longer receive the signal emitted from the wireless signal emitting device (131) and the external signal processing device (9) will close the upper airtight sealing gate (121). At the same time, the lower airtight sealing gate (122) will automatically open under the control of the external signal processing device (9). Because the float (13) in the columnar container (12) has discharged the volume of water equal to that of the float (13) and because some air has entered the top end of the columnar container (12) when the upper airtight sealing plate is opened, the water level in the columnar container (12) will be lowered when the upper airtight sealing gate (121) is closed and the lower airtight sealing gate (122) is opened. Therefore, the electromagnetic valve (51) under the control of the external signal processing device (9) will be opened, the negative pressure tank (5) will quickly evacuate the small amount of air in the columnar container (12) and then the electromagnetic valve (51) will be closed again. As the upper airtight sealing gate (121) is closed, the float (13) removed out of the columnar container (12) will be moved to position A in the figure. The float holding part (211) installed on the potential energy-kinetic energy conversion device (2) is located just below position A. When the float (13) is released and dropped onto the float holding part (211), the extension arm (21) will rotate in the direction indicated by the arced arrow indicated in the figure under the action of the gravity and the rotating axle (22) will also be rotated. The transmission mechanism (3) will transmit the rotating motion to the electric power generator (4). As the extension arm (21) rotates to position B in the figure, the float holding part (211) of the next adjacent extension arm (21) will be located just below position A. At the same time, the float (13) will be released from the float holding part (211) and dropped into the water pool (11) again. After repeating the floating process mentioned above, the float (13) would return to position A in the figure again to start another cycle of operation.

During the cycling operation of the float (13) mentioned above, the height of position A is much higher than that of position B and thus the potential energy of the float (13) at position A is greater than that at position B. Therefore, during the process of rotation of the extension arm (21), the potential energy is released, converted to kinetic energy and taken up by the transmission mechanism (3). In this way, the potential energy of the float (13) is exported. When a mechanical energy storage part is installed in the transmission mechanism (3) (for example, a spiral power spring), the transmission mechanism (3) can constantly transmit kinetic energy to the electric power generator (4) to enable the electric power generator (4) to generate electricity outwards. In this way, raising of the potential energy of the float (13) and conversion of the potential energy to electric energy can be completed.

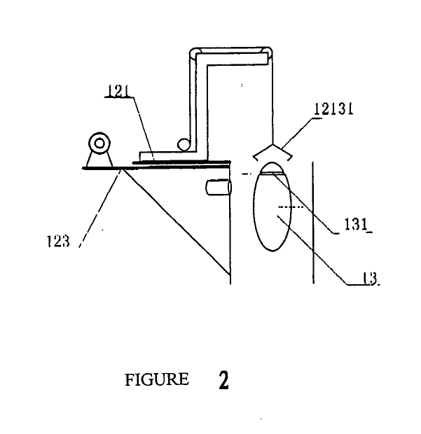

FIG. 2 is a schematic diagram showing the structure of an auxiliary float raising device. In this figure, when the upper airtight sealing gate (121) is slid open by the sliding pair on the surface of the platform (123), the grab hook (12131) will drop down to buckle up the top part of the float (13). In order to buckle up the float (13), the depressed groove is installed on the surface of the top part of the float (13).

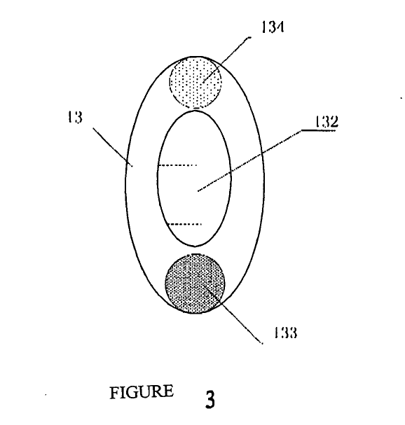

FIG. 3 is a schematic diagram showing the structure of the float. In the present example, the outer shape of the float (13) is flat, oval and streamlined. Its inner part is hollow and filled with the specific gravity adjusting liquid (132). By adjusting the specific gravity, a very precise specific gravity value of the float (13) can be obtained to make the movement of the float (13) smooth. In order to control the posture of the float (13) during its movement, the density of the lower end (133) of the float (13) is made to be greater than that of the upper end (134) during the manufacturing process of the float (13). In this way, the float (13) can always maintain the same posture during its movement in water.

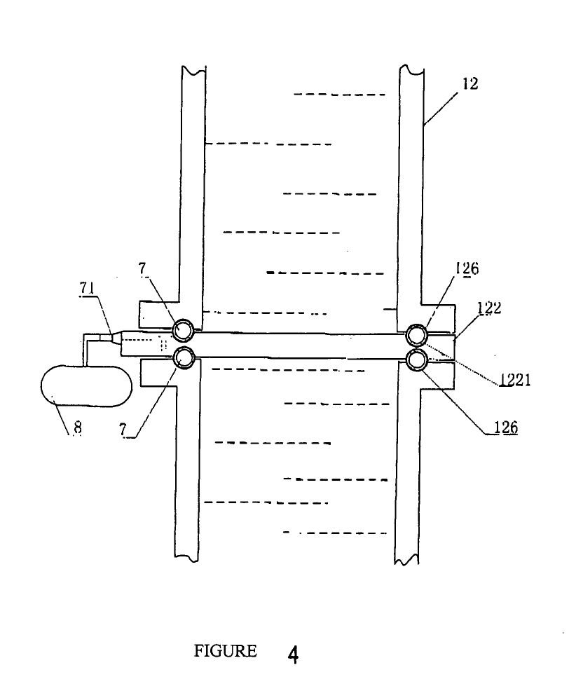

In the present example, when the upper airtight sealing gate is opened, the closed lower airtight sealing gate can maintain the heights of the two partitioned water columns without decreasing their levels. In this way, airtight sealing can be achieved relatively effectively. As shown in FIG. 4, a ring-shaped depressed groove (1221) is installed on each of the upper and lower surfaces of the lower airtight sealing gate (122) that makes contact with the side walls of the two columnar containers (12). The similar, corresponding, ring-shaped depressed groove (126) is also installed on each of the corresponding cross-sectional surfaces of the side walls of the columnar container (12). The ring-shaped depressed grooves (1221) and the corresponding ring-shaped depressed grooves (126) will make contact with each other when the lower airtight sealing gate (122) is closed. Any other suitable seal, gate or valve may be used.

The airtight hollow sealing rubber ring (7) that can be filled with air is pre-installed in each of the ring-shaped depressed grooves (1221). The air filling port (71) of the airtight sealing rubber ring (7) is installed at the side surface of the lower airtight sealing gate (122) and is connected to the external air compressor (8). After the lower airtight sealing gate (122) is closed, the airtight sealing rubber ring is filled with air to allow it to have at least one standard atmospheric pressure. At that time, the airtight sealing rubber ring (7) will fill the ring-shaped depressed grooves (1221) and the corresponding ring-shaped depressed grooves (126) to ensure no leakage of water partitioned in the columnar container (12) and also to prevent reverse flow of water into the water pool.

In the example mentioned above, the diameter of the water column is 1 m. The outer shape of the float is streamlined and its cross section is oval shaped. The long axis radius is 0.40 m and the short axis diameter is 0.20 m. Its approximate volume is 0.283 m³. The float density is estimated to be 0.9×10³ kg/m³ and the float mass is 254 kg.

When the float reaches the releasing point at the top of the water column (point A in FIG. 1), it will have a potential energy of 24,892 Joules (J).

As the float enters the water pool, it has to utilize inertia to sink a certain distance. This distance needs to be only a little greater than the height of the float. Because the density of the float is close to that of water and its external shape is streamlined, it will sink relatively easily. Experimental results reveal that use of a height of 1 m for dropping the float into water as the initial starting point will satisfy the requirements mentioned above (point B in FIG. 1). When the float is at the level where it is to be dropped into the water pool, its potential energy is calculated to be 2,489 Joules (J).

The data described above indicate that the float at the initial starting point and the float at the releasing point have the greatest potential energy difference. If most of the potential energy difference can be used for the outside work, then one fall of the float can output greater than 20,000 J of work. Experimental results and scientific calculation reveal that the electric power generation facility consumes a total of about 10,000 J for one cyclic operation of the float. Therefore, during the operation in the present example, every cycle of the float operation can output externally at least 10,000 J of electric energy.

If the diameter of the water column used in the present example is increased and the volume of the float is increased correspondingly to increase its mass, even a greater potential energy difference can be achieved and a greater amount of electric energy can be output in the present example.

Finally, the example described above is used only for explaining the present invention and the technical design of the present invention will not be restricted by this example. In spite of the fact that this example was used as a reference to explain the present invention in detail, general technical personnel in this field of work should understand that details of the exemplary embodiments can still be modified or equivalently replaced and any modifications or local replacements within the spirit and scope and rage of equivalents of the present invention.

Exemplary embodiments pertains generally to a kind of potential energy electric power generating facility preferably based on atmospheric pressure, which includes an electric power generator and a transmission mechanism. The output terminal of the transmission mechanism is connected to the generator input terminal. It also includes a potential energy raising device and a potential energy-kinetic energy conversion device. The potential energy raising device includes a liquid pool filled with a liquid, a columnar container and a float. The exemplary potential energy-kinetic energy conversion device includes more than one extension arm, a rotating axle and a support structure, but other transmission systems may be used. Preferably, all the extension arms are fixed on the rotating axle. The rotating axle may be erected on the support frame and connected to the rotation input terminal of the rotating mechanism. Without being bound by any particular theory of operation, it is believed that these embodiments utilize Torricelli's experimental phenomenon and the energy produced by the atmospheric pressure to create two liquid surfaces with different heights; the potential energy of the float is raised through the buoyancy of the liquid. In addition, the electric energy conversion enables these embodiments to create a new way of long-term utilization of a natural resource without causing any pollution.

A potential energy electric power generating facility may be based on atmospheric pressure, which includes an electric power generator and a transmission mechanism, the output terminal of the transmission mechanism being connected to the generator input terminal. The potential energy electric power generating facility contains a potential energy raising device and a potential energy-kinetic energy conversion device.

In some embodiments, the potential energy raising device includes a liquid pool filled with a liquid, a columnar container and a float. The bottom end of the columnar container is open and its top end is equipped with an upper airtight sealing gate. The specific gravity of the float is less than that of the liquid mentioned above but greater than that of air. The columnar container is erected on the liquid pool and its lower end is below the liquid surface. An air extraction mouth is installed above the upper airtight sealing gate and is connected externally to a vacuum pump for producing a negative pressure in the columnar container. A lower airtight sealing gate is also installed on the columnar container; it is used for partitioning the liquid in the columnar container. The distance between the positions of the lower airtight sealing gate and the liquid surface of the liquid in the columnar container is not less than the maximum outside size of the float. A guiding groove is installed in the liquid. The guiding groove is a semicircular tube and is equipped with an upward inlet port and an exit port. The exit port is located below the bottom end of the columnar container.

The potential energy-kinetic energy conversion device may include more than one extension arm, a rotating axle and a support structure. The bottom ends of all extension arms mentioned above may be uniformly distributed and fixed onto the rotating axle while the top ends are extended outwards along the diameter of the rotating axle and form a windmill-like rotating unit. A float holding part may be installed on each of the top ends of all extension arms. When the float moves out of the top part of the columnar container, one of the float holding parts may be positioned just below the bottom part of the float. The rotating axle may be erected on the support frame and is connected to the rotation input terminal of the transmission mechanism.

A platform may be installed horizontally on the outside of the top end of the columnar container, wherein the platform surface makes a sliding contact with the upper airtight sealing gate through a sliding pair so that the upper airtight sealing gate can reach in a loose sliding motion to the top end of the columnar container for carrying out a closing and opening operation.

An auxiliary float raising device may also be installed on the surface of the upper airtight sealing gate, such that when the upper airtight sealing gate opens, the auxiliary float raising device will raise the float out of the columnar container.

The auxiliary float raising device may be equipped with a winding engine and a cable hoist, one end of the cable being equipped with a grab hook capable of automatic closing/opening.

A conical guiding entrance port, which opens downwards, may be installed around the bottom end open port of the columnar container, which is used to guide the float, which is to be dropped into the liquid pool, into the columnar container.

The float may be a long oval body with two terminal parts, its cross-sectional area may be of an oval shape; its specific gravity may be 0.5-0.9 times that of the liquid; the float may be hollow and contain a liquid for adjusting the specific gravity of the float, and the two terminal ends of the float may have different densities.

A wireless signal generator may be installed on the surface of or inside the float and a wireless signal receiver may be installed on the upper airtight sealing gate and the lower airtight sealing gate. The wireless signal receiver will transfer the signal to the signal processing device installed additionally on the outside, and this signal processing device controls the opening and closing of the upper airtight sealing gate and the lower airtight sealing gate.

A negative pressure tank may also be installed at the location between the air extracting mouth and the outside vacuum pump, the negative pressure tank connected to the air extracting mouth through an electromagnetic valve, the electromagnetic valve controlled by the outside signal processing device, where the negative pressure tank can quickly extract out a small amount of air in the columnar container that has entered into the top end of the container as a result of internal opening of the upper airtight sealing gate.

A ring-shaped, depressed groove may be installed on the surface of the lower airtight sealing gate and on the corresponding position on the cross section of the columnar container making contact with the surface, the depressed groove is equipped with a hollow airtight rubber ring that can be filled with a gas, a gas filling port of the airtight rubber ring is installed on the side of the lower airtight sealing gate and is connected to an outside air compressor so that when the airtight rubber ring is filled with a gas, the airtight sealing of the lower airtight sealing gate can be enhanced further.

The liquid can be water, an aqueous solution of a compound or mercury.

Although a preferred ambient environment for the apparatus is in air at atmospheric pressure, the apparatus and method can be used in other environments, such as inside a chamber containing a gas (other than air, e.g., nitrogen or the like), or in an environment having a pressure above or below atmospheric pressure.

Some embodiments provide a potential energy electric power generating facility utilizing atmospheric pressure based on the various shortcomings and deficiencies encountered in the utilization of the natural resources mentioned above and also on the atmospheric pressure phenomena indicated in Torricelli's experiments. This facility utilizes the phenomenon in which a liquid in a vacuum or negative-pressure container erected on the surface of the liquid and connected to the liquid is lifted by the atmospheric pressure and also utilizes the buoyancy principle of a liquid. In this facility, the potential energy of a matter with its specific gravity being less than that of the liquid can be elevated in the container and the potential energy of the matter is subject to a potential energy-electric energy conversion process.

The technical designs are based on the principles of the law of universal gravitation, Archimedes' law and Torricelli's atmospheric pressure experimental phenomena.

It is well known that in Torricelli's famous experiment, the height of the mercury column used under one standard atmospheric pressure is 76 cm. The formula for calculating the intensity of pressure is as follows:
P=·g·H
in which P=intensity of atmospheric pressure
=liquid density
g=acceleration of gravity
H=liquid height

When mercury is replaced with water in the experiment, the water column height can be calculated using the formula mentioned above and would be 10.337 m.

When a static matter with its specific gravity less than that of water is placed at the bottom part of the water column, this matter will float upwards along the water column and will reach the top of the water column according to Archimedes' law. At this time, the potential energy of the matter will be elevated. When the matter is removed horizontally from the top of the water column and then released, the matter will fall freely under the action of universal gravitation, converting the potential energy to kinetic energy. The results of concrete experiments reveal that when the matter is returned to the original static position at the bottom of the water column, the matter will have higher energy than before. Acquisition of the energy is the result of the matter floating upwards along the water column. Therefore, if an external force is used to move the matter horizontally from the top of the water column and then released and these processes are repeated, then a constant cyclic movement of the matter in water and in air can be achieved.

During this cyclic movement of the matter, if the potential energy of the matter is converted to energy in other forms during its free fall, new energy that can be exported out can be produced as long as the energy released during the free fall is greater than the externally applied energy.

Each part and device needed in the technical designs mentioned above are installed according to the principle and the concept described above. The inside part of the columnar container is evacuated with the use of an external vacuum pump (reduce the inside pressure as much as possible). At this time, the upper airtight sealing gate is in a closed state and the lower airtight sealing gate is in an opened state. When the pressure inside the columnar container gradually reaches a vacuum state, the liquid in the liquid pool will enter the columnar container under the action of atmospheric pressure and will rise to a certain height. The height of the liquid at this time is equal to the height that can be reached when the intensity of the pressure on the liquid surface in the liquid pool produced by the liquid that has entered the columnar container becomes equal to the intensity of atmospheric pressure.

After the evacuation process is completed, the entire facility will assume the initial operation starting state. When the operation starts, the float is dropped into the liquid pool from the liquid surface. The dropping position is at the entrance port end of the guiding groove. The float enters the liquid and sinks downwards due to inertia. During this process, the guiding groove guides the float, moving downwards to the bottom end of the columnar container. After the sinking rate of the float becomes zero due to the resistance and the buoyancy of water, the float at the same time moves to the bottom end of the columnar container and then immediately starts to float. The locus of movement of the float in the liquid pool is close to a V shape. As the float reaches the bottom end of the columnar container, it immediately enters the columnar container and immediately rises to the highest liquid surface in the columnar container. During this process, the lower airtight sealing gate closes after the float in the columnar container passes through the lower airtight sealing gate. When the float reaches the top end (where the liquid surface is), the upper airtight sealing gate opens. As the lower airtight sealing gate closes, the liquid in the columnar container is partitioned. Therefore, when the upper airtight sealing gate opens, the liquid in the columnar container will not flow back into the liquid pool. When the float is removed from the top end of the columnar container through the upper airtight sealing gate and moves horizontally to the position where the float is to be dropped into the liquid pool, a float holding part installed on the potential energy-kinetic energy conversion device will be placed just below the float. As the float is released, it will drop onto the float holding part. Because of gravity, the float will press down the extension arm and rotate the whole windmill-like rotating unit. When the float holding part rotates and reaches the lowest possible position, the float will get away from the float holding part and again will drop into the liquid pool.

During the process of rotation of the windmill-like rotating unit induced by the float, the upper airtight sealing gate will close again and at the same time the lower airtight sealing gate will open again. Because the float occupies a certain space and because a small amount of air will enter the top end of the columnar container as the upper airtight sealing gate opens, the liquid level in the columnar container will drop after the float leaves the columnar container. At that time, a vacuum pump will be actuated to evacuate the excess air in the top part of the columnar container and the liquid level will return to the initial position.

In addition, the rotation of the windmill-like rotating unit will rotate the electric power generator through the action of the transmission mechanism, generating electric power.

When the extension arm holding the float rotates downwards, the other extension arm located next to and above the one holding the float will rotate in the direction toward the top part of the columnar container. As the float leaves the float holding part and starts to fall freely, another float holding part installed on another extension arm next to and above the extension arm will stop at the position just below the position where the float is to be released. During this process, the positions of all parts will return to the initial operation status.

The entire facility will repeat the processes mentioned above after the float released from the float holding part drops again into the liquid pool. In this way, the float will continuously and repeatedly undergo the processes of dropping into and floating up the liquid pool, inducing rotation of the windmill-like rotating unit and convert the potential energy of the float to electric energy.

During the operation of the facility, the rotation of the windmill-like rotating unit is intermittent. In order for the electric power generator to rotate continuously, an energy storage part may be installed in the transmission mechanism to make the output rotating axle rotate continuously to achieve the objective mentioned above. Or, a multiple number of potential energy raising devices may be installed to allow the release of each float to proceed according to the specified time and sequence. At the same time, by increasing the length of the rotating axle and by correspondingly installing a multiple number of windmill-like rotating units, the rotating axle of the potential energy-kinetic energy conversion device can be made to rotate constantly to provide the electric power generator with uninterrupted kinetic energy.

In the technical design, the height of the columnar column can be determined precisely from the atmospheric pressure, the specific gravity of the liquid and the negative pressure value inside the columnar container. When the atmospheric pressure is equal to one standard atmospheric pressure, water is used as the liquid and the negative pressure value is equal to about 0, the height of the columnar container can be set to be 10.33 m based on calculation.

After the float finishes floating, it will acquire potential energy which is much greater than its initial potential energy at the time when it is dropped into the liquid pool. After the float induces operation of the potential energy-kinetic energy conversion device, its kinetic energy is converted to electric energy through the potential energy-kinetic energy conversion device. The electric power thus generated is greater than the amount of energy consumed in the operation of such parts as the upper and lower airtight sealing gates, the vacuum pump, the auxiliary float raising device, etc. Therefore, the embodiment can be completely capable of constantly providing the energy needed externally.

It can be seen from the technical design described above that the gravity of the earth itself allows the atmospheric layer covering the earth to have inexhaustible pressure energy. The embodiments utilize the energy of atmospheric pressure to create liquid surfaces with different levels and utilizes the buoyancy of the liquid to increase the potential energy of a float. During the cyclic operation of the float, the atmospheric pressure constantly provides the liquid with the energy needed for increasing the potential energy of the float. Essentially, the energy of the atmospheric pressure is extracted and converted to a new natural resource free of any pollution for long-term use by human beings.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A machine, comprising:
a potential energy raising device comprising:
a base container containing a liquid,
a columnar container having an upper gate disposed approximately at the top of the columnar container, the columnar container extending above the base container and a bottom end of the columnar container being below a liquid surface of the base container;
a lower gate located to partition the liquid in the columnar container
a float having a density smaller than a density of the liquid and larger than an ambient gas density, the float capable of being dropped from approximately the top of the columnar container;
a gas extraction path coupled to the upper gate and coupled to a pump to extract gas from the columnar container; and
a guide disposed in the liquid to guide the float into a lower part of the columnar container, so the float can float upwards in the columnar container; and
a potential energy-kinetic energy conversion mechanism disposed near the potential raising device, for converting a potential energy of the float into kinetic energy when the float drops.

2. The power generating machine of claim 1, wherein the potential energy-kinetic energy conversion device comprises a plurality of extension arms, a rotating axle, a plurality of float holding parts, and a supporting frame.

3. The power generating machine of claim 2, wherein inward ends of the extension arms are uniformly distributed and connected onto the rotating axle; outward ends of the extension arms are extended outwards approximately perpendicular to the rotating axle rotating unit; each outward end is connected one float holding part; the rotating axle is supported by the supporting frame and is connected to the transmission mechanism.

4. The machine of claim 1, wherein the guide is a semicircular tube comprising an upward inlet port and an exit port;
the exit port disposed below the bottom end of the columnar container.

5. The machine of claim 1, further comprising:
a platform horizontally disposed outside a top end of the columnar container wherein a surface of the platform makes a sliding contact with the upper gate through a sliding pair so that the upper gate can reach in a loose sliding motion to the top end of the columnar container for carrying out a closing and opening operation.

6. The machine of claim 5, further comprising:
an auxiliary float raising device disposed on a surface of the upper gate;
wherein the auxiliary float raising device moves the float out of the columnar container when the upper gate opens.

7. The machine of claim 6, wherein the auxiliary float raising device comprises a winding engine, a cable, and a grab hook which is capable of automatic grabbing and releasing.

8. The machine of claim 1, further comprising:
a conical guiding entrance port disposed around the bottom end of the columnar container to guide the float which drops into the liquid in the base container into the columnar container.

9. The machine of claim 1, wherein the float is in an oval-like shape with a density ranging approximately from 0.5 to 0.9 times of the liquid's density;
the float further comprising a top terminal, a bottom terminal, and a hollow part wherein the top terminal's density is different from the bottom terminal's density; the hollow part contains density adjusting liquid.

10. The machine of claim 1, further comprising a wireless signal emitter disposed on or in the float, a first wireless signal receiver disposed on the upper gate, a second wireless signal receiver disposed on the lower gate, and a signal processing device receiving signals from the first and the second wireless signal receivers to control an opening and closing of the upper gate and the lower gate.

11. The machine of claim 10, further comprising a negative pressure tank connected to the gas extraction path; a valve disposed between the negative pressure tank and the gas extraction path and controlled by the signal processing device.

12. The machine of claim 1, further comprising a ring-shape groove disposed on the lower gate and adjacent portion of the columnar container, a rubber ring, and a compressor;
wherein the airtight rubber is connected to the compressor.

13. The machine of claim 1, wherein the liquid is one of the group consisting of water, an aqueous solution of a compound, or mercury.

14. An electric power generating machine, comprising:
an electric power generator;
a transmission mechanism connected to the generator, comprising a potential energy raising device and a potential energy-kinetic energy conversion device;
the potential energy raising device comprising a base container containing a liquid, a columnar container, a float, an upper airtight sealing gate, a lower airtight sealing gate, a gas extraction path, a vacuum pump, and a guide;
wherein a bottom end of the columnar container is open and a top end of the columnar container is equipped with an upper sealing gate; the float has a density smaller than the liquid's density and larger than an ambient gas density; the columnar container extends above the base container; the bottom end of the columnar container is below a liquid surface of the base container; the upper sealing gate is disposed approximately on the top end of the columnar container; the gas extraction path is coupled to the upper sealing gate to extract gas in the columnar container by the vacuum pump; the lower sealing gate is disposed on the columnar container to partition the liquid in the columnar container; the guide is disposed in the liquid to guide the float into the bottom end of the columnar container;
the potential energy-kinetic energy conversion device comprising a plurality of extension arms, a rotating axle, a plurality of float holding parts, and a supporting frame;
wherein inward ends of the extension arms are uniformly distributed and connected onto the rotating axle; outward ends of the extension arms are extended outwards approximately perpendicular to the rotating axle rotating unit; each outward end is connected one float holding part; the rotating axle is supported by the supporting frame and is connected to the transmission mechanism.

15. The machine of claim 14, further comprising:
an auxiliary float raising device disposed on a surface of the upper gate;
wherein the auxiliary float raising device moves the float out of the columnar container when the upper gate opens.

16. The machine of claim 15, wherein the auxiliary float raising device comprises a winding engine, a cable, and a grab hook which is capable of automatic grabbing and releasing.

17. The machine of claim 14, further comprising:
a conical guiding entrance port disposed around the bottom end of the columnar container to guide the float which drops into the liquid in the base container into the columnar container.

18. The machine of claim 14, wherein the float is in an oval-like shape with a density ranging approximately from 0.5 to 0.9 times of the liquid's density;
the float further comprising a top terminal, a bottom terminal, and a hollow part wherein the top terminal's density is different from the bottom terminal's density; the hollow part contains density adjusting liquid.

19. The machine of claim 14 further comprising a wireless signal emitter disposed on or in the float, a first wireless signal receiver disposed on the upper gate, a second wireless signal receiver disposed on the lower gate, and a signal processing device receiving signals from the first and the second wireless signal receivers to control an opening and closing of the upper gate and the lower gate.

20. The machine of claim 19, further comprising a negative pressure tank connected to the gas extraction path; a valve disposed between the negative pressure tank and the gas extraction path and controlled by the signal processing device.

21. The machine of claim 14, further comprising a ring-shape groove disposed on the lower gate and adjacent portion of the columnar container, a rubber ring, and a compressor;
wherein the airtight rubber is connected to the compressor.

22. The machine of claim 14, wherein the liquid is one of the group consisting of water, an aqueous solution of a compound, or mercury.
